(19) United States
(12) Patent Application Publication
(10) Pub. No.: US 2023/0093451 A1
(43) Pub. Date: Mar. 23, 2023

(54) STATE-DEPENDENT ACTION SPACE QUANTIZATION

(71) Applicant: Google LLC, Mountain View, CA (US)

(72) Inventors: Robert Dadashi-Tazehozi, Paris (FR); Olivier Claude Pietquin, Lille (FR); Léonard Hussenot Desenonges, Paris (FR); Matthieu Florent Geist, Ancy-Dornot (FR); Anton Raichuk, Pfaffikon (CH); Damien Vincent, Zurich (CH); Sertan Girgin, Paris (FR)

(21) Appl. No.: 17/947,985

(22) Filed: Sep. 19, 2022

Related U.S. Application Data
(60) Provisional application No. 63/245,780, filed on Sep. 17, 2021.

(51) Int. Cl. G06N 3/04; G06N 3/08

(52) U.S. Cl. CPC G06N 3/0454; G06N 3/08

(57) ABSTRACT

Methods, systems, and apparatus, including computer programs encoded on a computer storage medium, for controlling agents. In particular, an agent can be controlled using a discretization neural network that generates a state-dependent discretization of an original action space and a policy neural network that is used to select an action from the state-dependent quantization rather than from the original action space.

### CROSS-REFERENCE TO RELATED APPLICATION

This application claims priority to U.S. Provisional Application No. 63/245,780, filed on Sep. 17, 2021. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to attempt to perform a task in the environment. In particular, the system uses a discretization neural network that performs state-dependent action space quantization, i.e., that maps a large, original action space to a smaller action space in a manner that depends on the current state of the environment at any given time step.

Particular embodiments of the subject matter described in this specification can be implemented so as to realize one or more of the following advantages.

The described techniques use a learned state-dependent action discretization technique in order to allow a policy neural network that has been trained using a discrete action, as opposed to a continuous action, reinforcement learning (RL) technique to control an agent that has a continuous action space or another type of large and complex action space. In particular, the large and complex action space makes directly controlling the agent using the policy neural network ineffective or impossible, i.e., because the policy neural network cannot effectively search through such a large space to identify the “best” action to perform at any given time step. By instead using the discretization neural network, the policy neural network only needs to select the best action from a smaller set of actions that are proposed by the discretization neural network and can effectively control the agent to perform a given task.

By discretizing the action space, any discrete action deep RL algorithm can be applied to a continuous control problem, making the training of the policy neural network more sample efficient and improving the ability of the algorithm to explore the environment and the action space, thereby improving the performance of the trained policy neural network.

Existing discretization techniques suffer from complexity or the curse of dimensionality, hurting the performance of the policy neural network in controlling the agent. Because the described discretization techniques are learned and state-dependent, they avoid these issues and allow the policy neural network to effectively control the agent.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a diagram showing how the action selection system selects an action at a given time step.

FIG. 3 is a flow diagram of an example process for selecting an action.

FIG. 4 is a flow diagram of an example process for training the discretization neural network.

Like reference numbers and designations in the various drawings indicate like elements.

### DETAILED DESCRIPTION

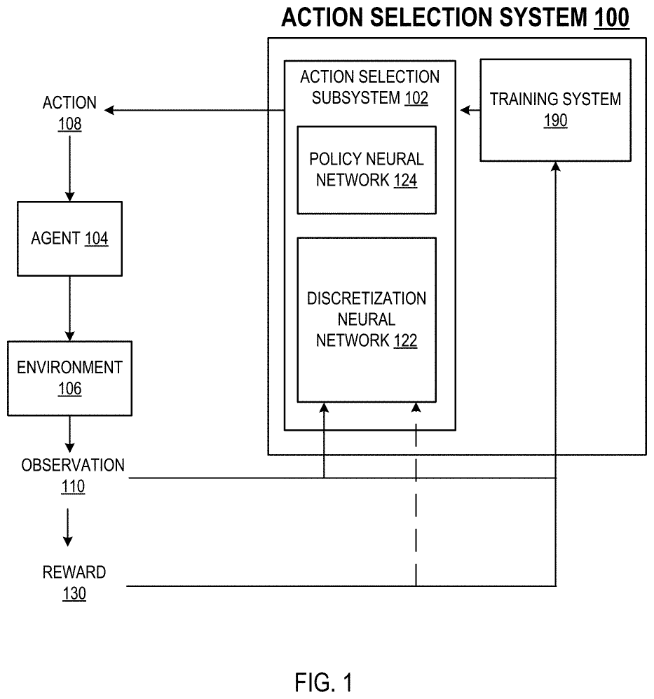

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during the performance of an episode of the task. As a general example, the task can include one or more of, e.g., navigating to a specified location in the environment, identifying a specific object in the environment, manipulating the specific object in a specified way, and so on. More generally, the task is specified by received rewards, i.e., such that an episodic return is maximized when the task is successfully completed. Rewards and returns will be described in more detail below. Examples of agents, tasks, and environments are also provided below.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent performs the action 108, the environment 106 transitions into a new state and the system 100 receives a reward 130 from the environment 106.

Generally, the reward 130 is a scalar numerical value and characterizes the progress of the agent 104 towards completing the task.

As a particular example, the reward 130 can be a sparse binary reward that is zero unless the task is successfully completed as result of the action being performed, i.e., is only non-zero, e.g., equal to one, if the task is successfully completed as a result of the action performed.

As another particular example, the reward 130 can be a dense reward that measures a progress of the agent towards completing the task as of individual observations received during the episode of attempting to perform the task, i.e., so that non-zero rewards can be and frequently are received before the task is successfully completed.

While performing any given task episode, the system 100 selects actions in order to attempt to maximize a return that is received over the course of the task episode.

That is, each at time step during the episode, the system 100 selects actions that attempt to maximize the return that will be received for the remainder of the task episode starting from the time step.

Generally, at any given time step, the return that will be received is a combination of the rewards that will be received at time steps that are after the given time step in the episode.

For example, at a time step t, the return can satisfy:
Σᵢγ^{i-t-1}rᵢ,
   where i ranges either over all of the time steps after tin the episode or for some fixed number of time steps after t within the episode, γ is a discount factor that is greater than zero and less than or equal to one, and rᵢ is the reward at time step i.

To do so, at each time step in the episode, an action selection subsystem 102 of the system 100 uses a discretization neural network 122 and a policy neural network 124 to select the action 108 that will be performed by the agent 104 at the time step.

Generally, in order to select the action, the subsystem 102 must select an action from an “original” action space that represents the set of controls for the agent 104. The actions in the original action space are represented as vectors having a fixed dimensionality, with each dimension having a specified range. For example, when the agent is a robot or other mechanical agent, the actions in the space can each be a vector of torques or other control inputs for each of multiple control elements of the mechanical agent. This will be described in more detail below.

The original action space is a large action space that contains a very large number of actions.

For example, the action space can be a continuous action space, a large discrete action space, or a hybrid action space.

A continuous action space is one that contains an uncountable number of actions, i.e., for each dimension, the action vector can take any value that is within the range for the dimension and the only constraint is the precision of the numerical format used by the system 100.

A hybrid action space is one where certain dimensions can take only a discrete, countable number of values, i.e., that are constrained by more than just the numerical format used by the system 100. In other words, a hybrid action space is one in which each action is composed of multiple sub-actions, with one or more of the sub-actions being selected from a continuous space and one or more other actions being selected from a discrete action space.

Generally, however, the action space contains a very large number of possible actions, making it difficult or impossible for the agent 104 to be effectively controlled by a policy neural network 124 that is trained using a discrete action reinforcement learning technique.

In particular, when the number of actions in an action space is finite and small, computing the maximum of an action-value function (that maps action-observation pairs to an estimate of the return to be received if the action is performed) is straightforward (and implicitly defines a greedy policy for controlling the agent). Thus, the “best” action, i.e., the one that is predicted to maximize the received return, is readily identifiable at any given time step.

In the large action space setup, determining the maximum action is significantly more difficult and may not be computationally tractable, i.e., because it requires searching through either a continuous space of possibilities or through a very large number of actions. Thus, the policy neural network 124 either directly optimizes the expected value function that is estimated through Monte Carlo rollouts, which makes it demanding in interaction with the environment, or optimizes a parametrized state-action value function, which introduces additional sources of approximations and can degrade quality.

To account for this, the system 100 uses the discretization neural network 122.

The discretization neural network 122 is configured to receive an observation 110 characterizing a state of the environment and to process the observation 110 to assign a respective action from the large action space to each action index in a fixed set of action indices.

That is, the discretization neural network 122 outputs a fixed number of actions from the action space arranged according to an output order and the “action index” of a given action references a position of the action in the output order. In other words, each output generated by the neural network 122 includes K total actions with indices ranging from 1 to K, where K is a fixed number that is less than the total number of actions in the original action space. For example, K can be a very small number relative to the number of actions in the original action space, e.g., K can be equal to 10, 15, or 20 while the number of possible actions in the original action space is uncountable or exceeds 10,000 total actions.

That is, the discretization neural network 122 generates a state-dependent assignment of actions to action indices, with different proper subsets of actions from the original action space being assigned to the action indices in response to different observations.

Prior to using the discretization neural network 122 jointly with the policy neural network 124, a training system 190 within the system 100 or another training system can train the discretization neural network 122 on demonstration data generated from interactions of a demonstration agent, e.g., an agent being controlled by a fixed already-learned policy, an agent being controlled by a random policy, or an agent being controlled by a user. Thus, the training system 190 trains the discretization neural network 122 so that the neural network 122 assigns actions to the action indices that are predicted to be similar to the action or actions that would likely be performed by the demonstration agent in response to the corresponding observations.

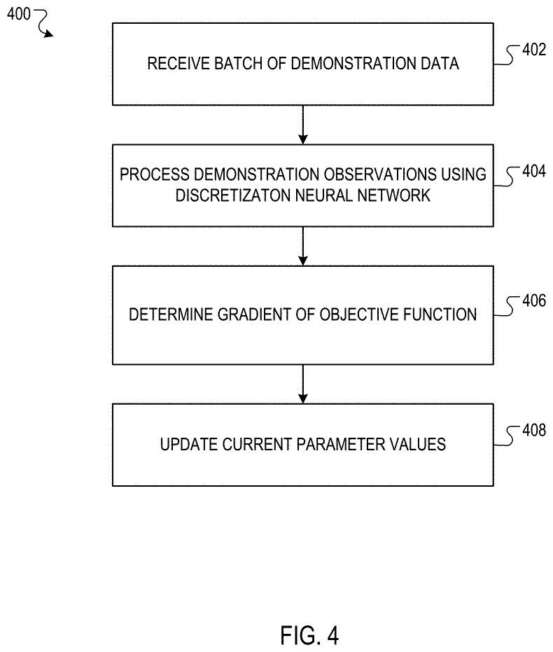

Generally, the training system only needs to have access to a relatively small amount of demonstration data, e.g., relative to the amount of data that would be required to train the policy neural network 124 from scratch, minimizing the overhead of training the discretization neural network 122 on the overall training process. Training the discretization neural network 122 is described in more detail below with reference to FIG. 4.

The discretization neural network 122 can have any appropriate neural network architecture.

As a particular example, however, the discretization neural network 122 can have an encoder neural network that includes one or more hidden layers and generates an encoded representation of the observation 130 and then a respective decoder for each of the action indices. The encoded representation of the observation is an ordered collection of numerical values that collectively represent the observation, e.g., a vector or a matrix of floating point or other numeric values that has a fixed dimensionality. The architecture of the encoder can depend on the type of data that is included in the observation 110. For example, when the observation includes an image, the encoder can include one or more convolutional layers, one or more self-attention layers, or both. When the observation includes one or more vectors of lower- dimensional data, the encoder can include one or more fully-connected layers.

Each decoder can include one or more hidden layers, e.g., one or more fully-connected neural network layers. The decoder for a given action index processes the encoded representation to regress an action from the original action space that is assigned to the given action index. That is, the decoder generates as output an action vector that represents an action from the original action space, i.e., that has the same dimensionality as the actions in the original action space and that has values that fall within the range of possible values for each dimension of the action vector.

The subsystem 102 then uses the policy neural network 124 to select one of the action indices in the fixed set and selects, as the action 108 to be performed by the agent 104 in response to the observation 130, the action that has been assigned to the selected action index.

The policy neural network 124 can have any appropriate neural network architecture that enables it to perform its described functions, e.g., processing a policy input that includes an observation 130 to generate a policy output that includes a respective score for each of the action indices.

For example, the policy neural network 124 can include any appropriate number of layers (e.g., 5 layers, 10 layers, or 25 layers) of any appropriate type (e.g., fully connected layers, convolutional layers, attention layers, transformer layers, etc.) and connected in any appropriate configuration (e.g., as a linear sequence of layers).

In one example, the policy output may include a respective Q-value for each action index in the fixed set. The system can process the Q-values (e.g., using a soft-max function) to generate a respective probability value for each action index, which can be used to select the action index (through greedy selection or sampling), or can select the action index with the highest Q-value. Alternatively, the system can apply an exploration policy, e.g., epsilon greedy, to the Q values to select an action index.

The Q value for an action index is an estimate of a “return” that would result from the agent performing the action assigned to the action index in response to the current observation and thereafter selecting future actions performed by the agent in accordance with current values of the policy neural network parameters and using the state-dependent assignments of actions to action indices generated by the discretization neural network.

In another example, the policy output may include a respective numerical probability value for each action index in the fixed set. The system can select the action index, e.g., by sampling an action index in accordance with the probability values for the action indices, or by selecting the action index with the highest probability value.

Generally, the training system 190 or a different training system trains the policy neural network 124 through discrete action reinforcement learning after training the discretization neural network 122.

“Discrete action reinforcement learning” refers to a reinforcement learning technique that is designed to train neural networks that generate outputs for discrete action spaces, e.g., that generate a respective probability for each action in the discrete action space or a respective Q values for each action in the discrete action space (and not, e.g., parameters of a continuous probability distribution over a continuous action space). The training system 190 can use any appropriate discrete action reinforcement learning technique for this training. One example of such a technique is a Deep Q Networks (DQN) technique. Another example of such a technique is a Munchausen DQN technique. Yet another example of such a technique is a Double DQN technique.

In some cases, the training data for the training of the policy neural network 124 includes only experience data that was generated through interaction with the environment 106 of an agent that is controlled by the policy neural network 124 and the trained discretization neural network 122.

In some other cases, the training data can include other data, e.g., demonstration data, that was not generated using the trained discretization neural network 122. In these cases, some experiences in the training data may include an action that would not be assigned to any of the action indices by the trained discretization neural network 122 by processing the corresponding observation. If this occurs, the training system 190 can replace the action in the experience with the closest action from the actions that are assigned to any of the action indices by the trained discretization neural network 122 before using the experience as part of the discrete action technique.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmachemical drug and the agent is a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

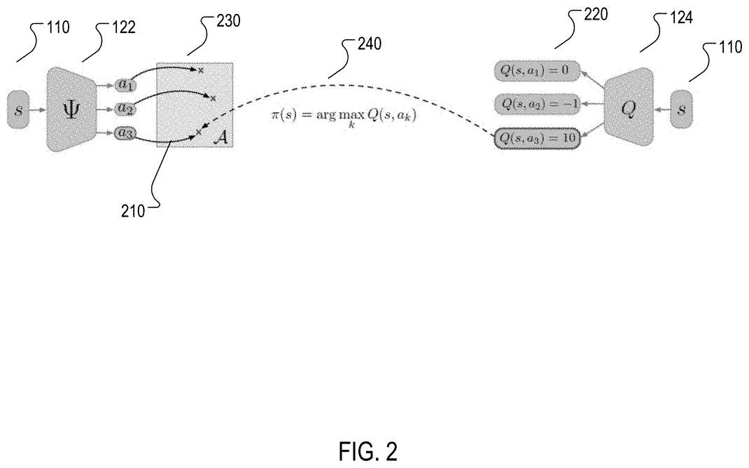

FIG. 2 is a diagram showing how an action is selected using the discretization neural network 122 and the policy neural network 124.

In particular, FIG. 2 shows a simplified example where the original action space is represented as a two dimensional rectangle 230 (denoted as “A” in the Figure) and the number action indices is K=3. That is, the original action space includes any two-dimensional point within the rectangle 230 and the discretization neural network 122 (denoted as w) performs state-dependent quantization to map each of the three action indices a1, a2, and a3 to a respective action, i.e., a respective point within the rectangle 230.

As shown in FIG. 2, the system receives the observation 110 (denoted as “s” in the Figure). The system process the observation 110 using the discretization neural network 122 to generate a respective mapping 210 for each of the action indices a1, a2, a3. The mapping maps each action index to a different point within the rectangle 230, i.e., to a different action from the original action space. For example, the discretization neural network 122 can process the observation 110 using an encoder neural network to generate an encoded representation of the observation 110 and then, for each of the action indices a1, a2, and a3, process the encoded representation 110 using a corresponding decoder to assign the action index to an action from the space. In the example of FIG. 2, each decoder can be configured to regress a two-dimensional vector that falls within the rectangle 230.

The system can also process an input that includes the observation 110 using the policy neural network 124 (denoted as “Q” in the Figure). In the example of FIG. 2, the policy neural network 124 is a Q neural network that generates a respective Q value 220 for each of the action indices conditioned on the observation 110, i.e., conditioned on the state of the environment. In the example of FIG. 2, the policy neural network 124 generates a Q value of 0 for action index a1, a Q value of −1 for action index a2, and a Q value of 10 for action index a3.

The system then selects one of the action indices using the policy network output, i.e., using the Q values. In the example of FIG. 2, the system selects the “argmax” action index, i.e., selects the action index a3 that has the highest Q value. The system then identifies 240, as the action to be performed by the agent in response to the observation 110, the action that was assigned to the selected action index, i.e., the action index a3, by the discretization neural network 122.

Thus, even though the action space includes all of the points within the rectangle 230, the policy neural network 124 only needs to compute Q values for three action indices in order to accurately control the agent in response to the observation 110.

In some implementations, the policy neural network 124 is not provided with any information that identifies which action was assigned to any given action index by the discretization neural network 122 at a given time step. That is, because the policy network 124 was trained using the already trained discretization neural network 122, the policy neural network 124 can accurately determine which type of action is likely to be assigned to which action indices given the current observation and can accurately generate the scores for the action indices even when the policy input does not identify which actions were assigned to the slots.

In some other implementations, the policy neural network 124 can receive data specifying the selected actions as part of the policy input.

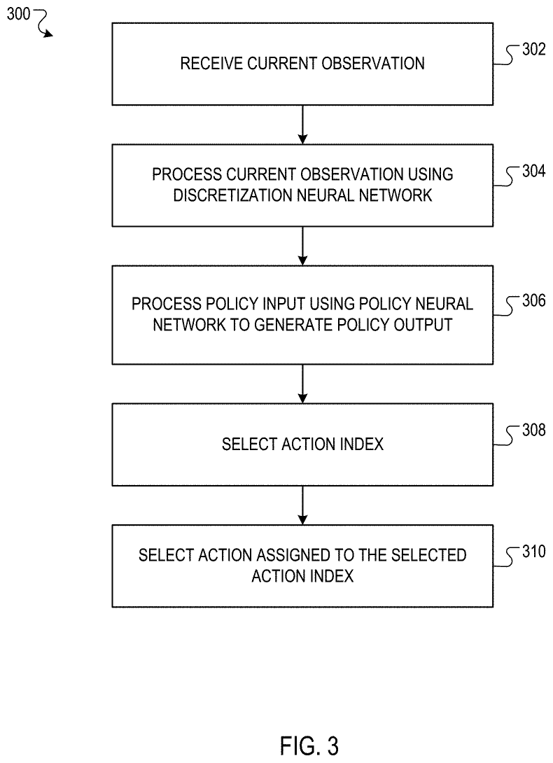

FIG. 3 is a flow diagram of an example process 300 for selecting an action. For convenience, the process 300 will be described as being performed by a system of one or more computers located in one or more locations. For example, an action selection system, e.g., the action selection system 100 of FIG. 1, appropriately programmed in accordance with this specification, can perform the process 300.

The system can perform the process 300 at each time step during a sequence of episodes, e.g., at each time step during a task episode. The system continues performing the process 300 until termination criteria for the episode are satisfied, e.g., until the task has been successfully performed, until the environment reaches a designated termination state, or until a maximum number of time steps have elapsed during the episode.

The system receives a current observation characterizing a state of the environment at the time step (step 302).

The system processes the current observation using the discretization neural network (step 304). As described above, the discretization neural network is a neural network that is configured to process the current observation to assign, to each action index in a set of action indices, a respective action from the original action space. Generally, the total number of action indices in the set of action indices is less than a total number of actions in the original action space.

The system processes a policy input that includes the current observation using a policy neural network that is configured to process the current observation to generate a policy output that comprises a respective score for each of the action indices (step 306). For example, the respective scores can be probabilities or can be Q-values.

The system selects an action index from the set of action indices using the policy output (step 308). For example, the system can select the argmax action index, i.e., the action index with the highest score.

The system selects, as the action to be performed by the agent in response to the current observation, the action that was assigned to the selected action index by the discretization neural network by processing the current observation (step 310).

The system then causes the agent to perform the selected action, e.g., by directly submitting a control input to the agent or by transmitting instructions or other data to a control system for the agent that will cause the agent to perform the selected agent.

FIG. 4 is a flow diagram of an example process 400 for training the discretization neural network. For convenience, the process 400 will be described as being performed by a system of one or more computers located in one or more locations. For example, an action selection system, e.g., the action selection system 100 of FIG. 1, appropriately programmed, can perform the process 400.

The system can repeatedly perform the process 400 on different batches of demonstration data to train the discretization neural network, i.e., to repeatedly update the values of the parameters of the discretization neural network (also referred to as the discretization parameters).

The system receives a batch of demonstration data, e.g., by sampling a batch that includes a fixed number of demonstration transitions or demonstration trajectories from a larger set of demonstration data (step 402). The demonstration data includes multiple demonstration transitions, with each demonstration transition including (i) a demonstration observation and (ii) an action from the original action space that was performed by an agent in response to the demonstration observation. The agent can be the same agent as the one that the system will control after training or can be a different, demonstration agent, e.g., an agent controlled by a human or a different control policy.

For each demonstration transition, the system processes the demonstration observation in the transition using the discretization neural network and in accordance with current values of the discretization parameters to assign a respective action from the original action space to each of the action indices (step 404).

The system determines a gradient with respect to the discretization parameters of an objective function that measures, for each demonstration transition, respective distances between the action in the demonstration transition and each of the actions assigned to the action indices by the discretization neural network by processing the demonstration observation in the demonstration transition (step 406).

Generally, the objective function encourages, for any given demonstration transition, at least one of the actions assigned to the action indices to be similar to the action in the demonstration transition.

As a particular example, the objective function can be a loss function that measures, for each demonstration transition, a soft minimum of the respective distances between the action in the demonstration transition and each of the actions assigned to the action indices by the discretization neural network by processing the demonstration observation in the demonstration transition.

As a more specific example, the loss function can satisfy:

$$- log ( {\sum }_{k = 1}^{K} exp ( \frac{- {‖ {Ψ}_{k} ( s ) - a ‖}^{2}}{T} ) ) ,$$

where K is the total number of action indices, a is the demonstration action in the demonstration transition, T is a temperature constant, and Ψₖ(s) is the action assigned to action index k by the discretization neural network.

As another more specific example, the loss function can satisfy:

$$- T log ( {\sum }_{k = 1}^{K} exp ( \frac{- {‖ {Ψ}_{k} ( s ) - a ‖}^{2}}{T} ) )$$

In both of these examples, the larger the temperature T is, the more the loss imposes all candidate actions that are assigned to action indices to be close to the demonstrated action. The lower the temperature T is, the more the loss only imposes a single candidate action to be close to the demonstrated action.

The system updates the current values of the parameters of the discretization neural network using the gradient (step 408). In particular, the system can apply an optimizer being used for the training, e.g., the Adam optimizer, the rmsProp optimizer, or the stochastic gradient descent optimizer, to the gradient and the current values to generate updated values of the discretization parameters.

After the training of the discretization neural network, i.e., after performing iterations of the process 400 until a termination criterion has been satisfied, e.g., a maximum number of iterations have been performed or the parameters of the discretization neural network have converged, the system can use the trained discretization neural network to train the policy neural network using a discrete action reinforcement learning technique.

For example, the system can repeatedly perform the process 300 using the trained discretization neural network and the policy neural network to generate experience tuples, i.e., by controlling the agent to interact with the environment.

Each experience tuple includes current observation, the selected action index, the next observation received in response to the agent performing the selected action, and the reward value received in response to the agent performing the selected action.

The system can store the experience tuple in a replay memory for use in training the policy neural network on experience tuples using the discrete action reinforcement learning technique. That is, the system can also repeatedly sample experience tuples from the replay memory during the training and use the sampled experience tuples as inputs to the discrete reinforcement learning technique to train the policy neural network.

The discrete RL technique can be any appropriate discrete RL technique, e.g., one of the DQN variants described above, with the only modification required being that the policy network learns to assign probabilities to action indices proposed by the trained discretization neural network rather than to actions from the original action space. In other words, rather than training the policy neural network to directly select actions that maximize expected returns, the system uses the discrete RL technique to train the policy neural network to select action indices that maximize expected returns given how actions are assigned to action indices by the trained discretization neural network. That is, by generating experiences using the trained discretization network, by modifying existing experiences using the trained discretization network (as described below), or both, the system trains the policy network to select action indices that maximize expected given the learned, state-dependent quantization scheme implemented by the trained discretization network.

In some implementations, the replay memory stores one or more experience tuples that include a selected action that would not be assigned to any of the action indices by the trained discretization neural network by processing the corresponding observation in the experience tuple. For example, the system can also include, in the replay memory, demonstration data that was used to train the discretization neural network or different demonstration data, e.g., demonstration data generated by a policy neural network trained using a continuation action reinforcement learning technique. In these implementations, for each of these experience tuples, prior to using the experience tuple to train the policy neural network, the system can replace the selected action in the experience tuple with a closest action to the selected action from the actions that are assigned to any of the action indices by the trained discretization neural network by processing the corresponding observation in the experience tuple. For example, the system can use a distance measure like Euclidean distance or cosine similarity to determine which assigned action is the “closest” action to the selected action.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a sub combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more computers for controlling an agent to interact with an environment by performing actions from an original action space, the method comprising:
receiving a current observation characterizing a current state of an environment;
processing the current observation using a discretization neural network that is configured to process the current observation to assign, to each action index in a set of action indices, a respective action from the original action space, wherein a total number of action indices in the set of action indices is less than a total number of actions in the original action space;
processing a policy input comprising the current observation using a policy neural network that is configured to process the current observation to generate a policy output that comprises a respective score for each of the action indices;
selecting an action index from the set of action indices using the policy output;
selecting, as an action to be performed by the agent in response to the current observation, the action that was assigned to the selected action index by the discretization neural network by processing the current observation; and
causing the agent to perform the selected action in response to the current observation.

2. The method of claim 1, wherein the action space is a continuous action space.

3. The method of claim 1, wherein the respective score for each of the action indices is a Q-value that represents an estimated return to be received if the agent performs the action that was assigned to the selected action index by the discretization neural network.

4. The method of claim 1, wherein the discretization neural network comprises:
an encoder neural network that includes one or more neural network layers and processes the observation to generate an encoded representation of the observation; and
a respective decoder neural network that includes one or more hidden layers for each of the action indices, wherein the respective decoder neural network for each action index processes the encoded representation for the action index to regress an action from the original action space that is assigned to the action index.

5. The method of claim 1, wherein the discretization neural network has been trained on a set of demonstration transitions.

6. The method of claim 5, wherein the policy neural network has been trained through a discrete action reinforcement learning technique after the training of the discretization neural network.

7. A method performed by one or more computers and for training a discretization neural network that has a plurality of parameter and that is configured to receive as input an observation characterizing a state of an environment and to process the observation in accordance with the parameters to assign, to each action index in a set of action indices, a respective action from an original action space, wherein a number of action indices in the set of action indices is less than a number of actions in the original action space, the method comprising:
receiving a batch of demonstration data that comprises a plurality of demonstration transitions, each demonstration transition comprising (i) a demonstration observation and (ii) an action that was performed by an agent in response to the demonstration observation;
for each demonstration transition, processing the demonstration observation in the transition using the discretization neural network and in accordance with current values of the parameters to assign a respective action to each of the action indices;
determining a gradient with respect to the parameters of the discretization neural network of an objective function that measures, for each demonstration transition, respective distances between the action in the demonstration transition and each of the actions assigned to the action indices by the discretization neural network by processing the demonstration observation in the demonstration transition; and
updating the current values of the parameters of the discretization neural network using the gradient.

8. The method of claim 7, wherein the objective function is a loss function that measures, for each demonstration transition, a soft minimum of the respective distances between the action in the demonstration transition and each of the actions assigned to the action indices by the discretization neural network by processing the demonstration observation in the demonstration transition.

9. The method of claim 8, wherein the loss function satisfies:
$$- log ( {\sum }_{k = 1}^{K} exp ( \frac{- {‖ {Ψ}_{k} ( s ) - a ‖}^{2}}{T} ) ) ,$$
wherein K is the total number of action indices, a is the action in the demonstration transition, T is a temperature constant, and Ψₖ(s) is the action assigned to action index k by the discretization neural network by processing the demonstration observation s.

10. The method of claim 8, wherein the loss function satisfies:
$$- T log ( {\sum }_{k = 1}^{K} exp ( \frac{- {‖ {Ψ}_{k} ( s ) - a ‖}^{2}}{T} ) ) ,$$
wherein K is the total number of action indices, a is the action in the demonstration transition, T is a temperature constant, and Ψₖ(s) is the action assigned to action index k by the discretization neural network by processing the demonstration observation s.

11. The method of claim 6, further comprising:
after training the discretization neural network, using the trained discretization neural network to train a policy neural network that is configured to process a policy input comprising a current observation to generate a policy output that comprises a respective score for each of the action indices.

12. The method of claim 11, wherein using the trained discretization neural network to train a policy neural network comprises:
generating, using the trained discretization neural network, an experience tuple that comprises the current observation, the selected action, a next observation received in response to the agent performing the selected action, and a reward value received in response to the agent performing the selected action; and
storing the experience tuple in a replay memory for use in training the policy neural network on experience tuples using a discrete action reinforcement learning technique.

13. The method of claim 12, wherein the replay memory stores one or more experience tuples that include a selected action that would not be assigned to any of the action indices by the trained discretization neural network by processing the corresponding observation in the experience tuple, and wherein the method further comprises: for each of the one or more experience tuples, prior to using the experience tuple to train the policy neural network, replacing the selected action in the experience tuple with a closest action to the selected action from the actions that are assigned to any of the action indices by the trained discretization neural network by processing the corresponding observation in the experience tuple.

14. The method of claim 11, wherein training the policy neural network comprises training the policy neural network to select action indices that maximize expected returns given how actions are assigned to action indices by the trained discretization neural network.

15. A system comprising one or more computers and one or more storage devices storing instructions that when executed by the one or more computers cause the one or more computers to perform operations for controlling an agent to interact with an environment by performing actions from an original action space, the operations comprising:
receiving a current observation characterizing a current state of an environment;
processing the current observation using a discretization neural network that is configured to process the current observation to assign, to each action index in a set of action indices, a respective action from the original action space, wherein a total number of action indices in the set of action indices is less than a total number of actions in the original action space;
processing a policy input comprising the current observation using a policy neural network that is configured to process the current observation to generate a policy output that comprises a respective score for each of the action indices;
selecting an action index from the set of action indices using the policy output;
selecting, as an action to be performed by the agent in response to the current observation, the action that was assigned to the selected action index by the discretization neural network by processing the current observation; and
causing the agent to perform the selected action in response to the current observation.

16. The system of claim 15, wherein the action space is a continuous action space.

17. The system of claim 15, wherein the respective score for each of the action indices is a Q-value that represents an estimated return to be received if the agent performs the action that was assigned to the selected action index by the discretization neural network.

18. The system of claim 15, wherein the discretization neural network comprises:
an encoder neural network that includes one or more neural network layers and processes the observation to generate an encoded representation of the observation; and
a respective decoder neural network that includes one or more hidden layers for each of the action indices, wherein the respective decoder neural network for each action index processes the encoded representation for the action index to regress an action from the original action space that is assigned to the action index.

19. The system of claim 15, wherein the discretization neural network has been trained on a set of demonstration transitions.

20. The system of claim 19, wherein the policy neural network has been trained through a discrete action reinforcement learning technique after the training of the discretization neural network.
